(19) United States
(12) Patent Application Publication
(10) Pub. No.: US 2006/0108485 A1
(43) Pub. Date: May 25, 2006

(54) FLEXIBLE, SELF-SUPPORTING CAMERA MOUNT

(75) Inventor: Joshua Enderle, New Orleans, LA (US)

Correspondence Address: JOSHUA THOMAS ENDERLE, 6015 ANNUNCIATION, NEW ORLEANS, LA, 70118, US

(73) Assignee: Joshua Enderle, New Orleans, LA (US)

(21) Appl. No.: 10/904,651

(22) Filed: Nov. 21, 2004

(51) Int. Cl. F16M 13/00

(52) U.S. Cl. 248/160; 248/176.1

(57) ABSTRACT

This invention is a small, lightweight, durable camera mounting device utilizing a flexible yet rigid shaft to securely self-support a camera for hands-free operation.

### CROSS-REFERENCE TO RELATED APPLICATIONS

Not Applicable

### BACKGROUND OF THE INVENTION

This invention relates to a camera mounting device. In particular, a mounting device that enables the camera to be mounted on various objects at any angle with relative ease without the need for a stable, level resting surface or hard to use equipment. This device is extremely durable and is small and lightweight enough to be easily stored in a pocket, purse or backpack.

The wide majority of camera mounting devices on the market today, in particular tripods and mono-pods, require a stable, semi-level platform or ground area on which to firmly rest. Without such a surface to rest, it is virtually impossible to take a steady, well framed picture. This type of equipment is often times awkward, cumbersome and can require quite a bit of effort properly set up.

My invention uses a ¼ inch bolt and is capable of attaching to any camera that utilizes an industry standard ¼ inch tripod mounting screw-hole. These screw-hole mounts are found on virtually all modern cameras, including digital. This industry standard ¼ inch mounting bolt is embedded in one end of a slender, bendable shaft, capable of easily, yet securely wrapping around any object up to a few inches in diameter. My invention can easily be attached to fixed objects as handrails, street-sign posts, tree limbs and furniture. My invention is also well suited for use in places where traditional tri-pod type devices would be unable to support the camera. This is due to its ability to wrap itself around a variety of objects, eliminating the need for a stable, level surface for supporting the tri-pod or similar device. The device surpasses all present day tripods in its ability to be mounted at virtually any height by simply attaching it to any free standing tall object. By taking advantage of remote controls or timer functions built into many modern cameras, it enables the user to take pictures of themselves “hands-free” without a third party. In addition to its ability to secure itself to countless objects, it can also be shaped in such a way as to form a free standing camera support that can be used in much the same way as a traditional table-top tri-pod.

### BRIEF SUMMARY OF THE INVENTION

My invention consists of a long, slender, bendable shaft capable of being securely wrapped around various objects while supporting a lightweight object from one end. The shaft itself consists of a metal wire surrounded in a soft, molded plastic capable of being re-bended and re-shaped repeatedly without loss of strength or stability. The shaft is of sufficient strength to firmly support a small, lightweight object attached to one end while wrapped around a free standing object or shaped in a way as to form a free standing support itself. The shaft is flexible enough to be easily wrapped around a variety of objects. Attached to one end of the shaft is a ¼ inch bolt, capable of firmly securing the shaft to an object equipped with a ¼ inch screw-hole. Such screw-holes are an industry standard found on virtually all modern cameras. The invention is designed primarily as a self-supporting mounting device for small cameras, though any object of appropriate size with a ¼ inch screw-hole could also be supported in a similar fashion.

### BRIEF DESCRIPTION OF THE DRAWINGS

FIG. 1 is an exploded perspective view of the invention.

FIG. 2 demonstrates a possible use for the invention, i.e. attaching a camera to a free standing object.

FIG. 3 is a cross-sectional view of the invention, detailing the various internal components.

### DETAILED DESCRIPTION OF THE INVENTION

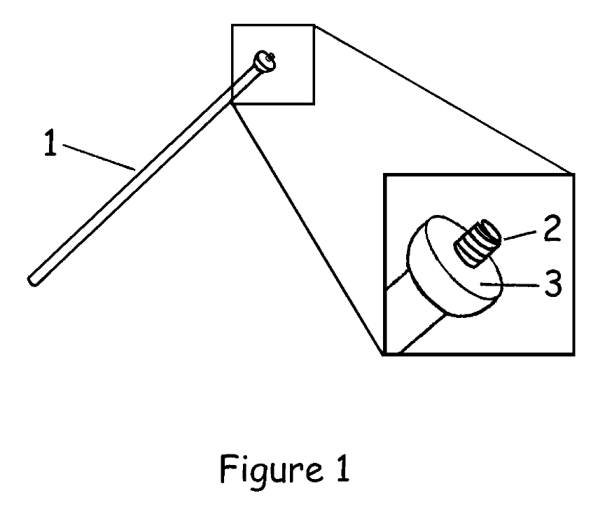

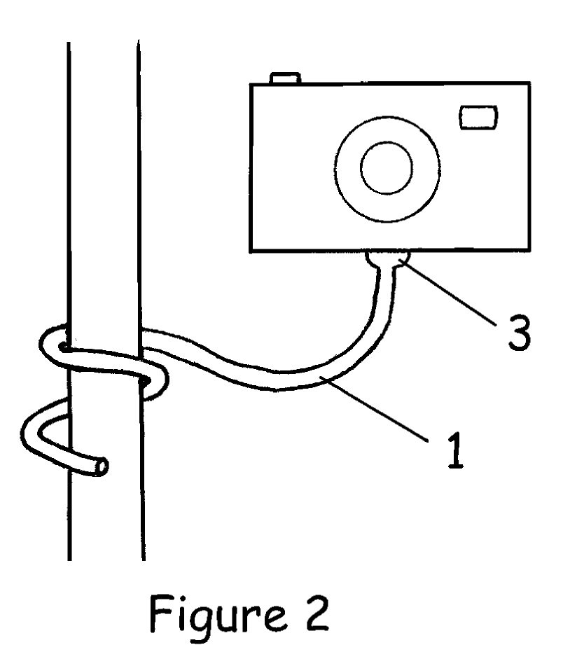

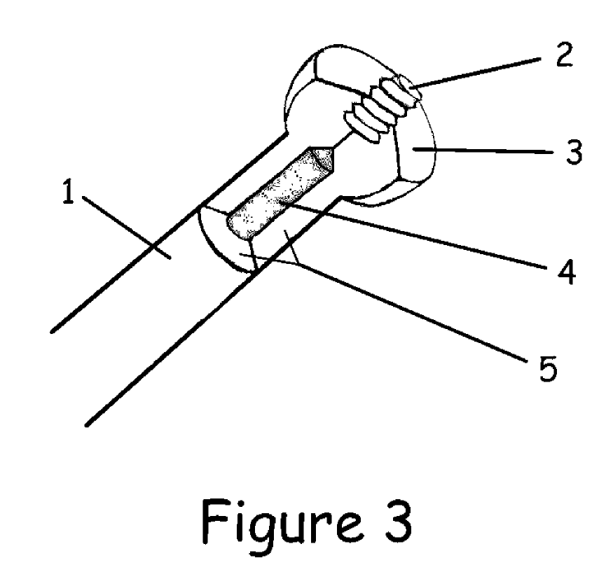

As shown in FIGS. 1, 2 and 3, my invention consists of a flexible shaft (1), a flared base (3) and an industry standard ¼ inch bolt (2) embedded in the base (3). As shown in FIG. 3, the flexible shaft (1) is made up of a metal wire (4) completely enclosed in molded plastic (5). As shown in FIG. 2, the industry standard ¼ inch bolt (2) is used to attach the flexible shaft (1) to any camera (or other device) utilizing a ¼ inch screw-hole. The flared base (3) acts to secure and stabilize the camera (or other device) to the shaft (1). As shown in FIG. 2, the flexible shaft (1) can be wrapped around any number of objects, in this case a narrow pole, securing the invention and the attached camera (or other device) to the desired object, in this case the pole. As shown in FIG. 3, a metal wire (4) runs the entire length of the flexible shaft. It is this flexible yet rigid metal wire (4) that gives strength and stability to the shaft (1), thus steadily supporting the mounted device. The flexible shaft (1) can be shaped in any fashion, allowing it to be wrapped around various objects as well as formed to create a free standing mount.

What is claimed is:

1. That this particular camera mounting device is universally adaptable to any modern camera with an industry standard ¼ inch screw-hole mount.

2. The device, because of its flexible shaft, is capable of being attached to various objects with relative ease.

3. The device can be used to support any device utilizing the same ¼ inch screw-hole found standard on most modern cameras. Although the device fits, and is primarily intended for, a camera, its design allows it to be used in a similar fashion with other objects as well.

4. The device is small enough and is lightweight enough to be easily and safely stored in a pocket, purse or backpack.

5. The device can be scaled up or down in size to accommodate larger or smaller devices, such as a video camera.
